(19) United States
(12) Patent Application Publication
(10) Pub. No.: US 2026/0082414 A1
(43) Pub. Date: Mar. 19, 2026

(54) Fast Secondary Cell Scheduling for Communication with Multiple Component Carriers

(71) Applicant: Apple Inc., CUPERTINO, CA (US)

(72) Inventors: Sairamesh NAMMI, Cupertino, CA (US); Divyaprakash P BHOJKUMAR, San Jose, CA (US); Murali NARASIMHA, Livermore, CA (US); Neha GOEL, Oceanside, CA (US); Sreevalsan VALLATH, Dublin, CA (US); Srinivasan BALASUBRAMANIAN, San Diego, CA (US)

(21) Appl. No.: 18/885,874

(22) Filed: Sep. 16, 2024

(51) Int. Cl. H04W 72/542; H04L 5/00; H04W 72/1263

(52) U.S. Cl. CPC H04W 72/542; H04L 5/001; H04W 72/1263

(57) ABSTRACT

An apparatus configured to generate, for transmission to a user equipment (UE), a Channel State Information (CSI) configuration for a first component carrier (CC) and a second CC of a carrier aggregation (CA) scheme, process, based on signaling received from the UE, CSI information for the first CC, determine CSI information for the second CC based on the CSI information for the first CC and generate, for transmission to the UE, scheduling information for the second CC based on the CSI information for the second CC.

### BACKGROUND

In Fifth Generation (5G) New Radio (NR) Multiple Input Multiple Output (MIMO) systems, the user equipment (UE) reports Channel State Information (CSI) either periodically, aperiodically, or using semi-persistent CSI reporting for each component carrier. Although the CSI Reference Signal (CSI-RS) is configured for each UE, the base station (e.g., gNodeB (gNB)) typically transmits a cell-specific CSI-RS that is common to all UEs in the cell for each component carrier. If a UE is configured with multiple component carriers, the UE reports the feedback for each component carrier on the uplink carrier. For example, if the UE is configured with 4 component carriers and 32 ports for each component carrier, the number of bits sent on the uplink may be significant causing a substantial overhead on the uplink channel. In addition, the network may not schedule a component carrier until the network receives the CSI report for the component carrier.

### SUMMARY

Some example embodiments are related to an apparatus having processing circuitry configured to generate, for transmission to a user equipment (UE), a Channel State Information (CSI) configuration for a first component carrier (CC) and a second CC of a carrier aggregation (CA) scheme, process, based on signaling received from the UE, CSI information for the first CC, determine CSI information for the second CC based on the CSI information for the first CC and generate, for transmission to the UE, scheduling information for the second CC based on the CSI information for the second CC.

Other example embodiments are related to an apparatus having processing circuitry configured to process, based on signaling received from a base station, a Channel State Information (CSI) configuration for a first component carrier (CC) and a second CC of a carrier aggregation (CA) scheme, determine, based on measurements of CSI reference signals (CSI-RS), CSI information for the first CC, determine CSI information for the second CC based on the CSI information for the first CC and generate, for transmission to the base station, one or more messages comprising the CSI information for the first CC and the CSI information for the second CC.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows a signaling diagram illustrating a call flow for CSI reporting between a base station and a UE according to the various example embodiments.

FIG. 5 shows a method for a base station to determine CSI for a secondary component carrier (SCC) based on CSI reported for a primary component carrier (PCC) according to various example embodiments.

FIG. 6 shows an example method 600 for a UE to simplify CSI reporting according to various example embodiments.

### DETAILED DESCRIPTION

The example embodiments may be further understood with reference to the following description and the related appended drawings, wherein like elements are provided with the same reference numerals. The example embodiments relate to determining relationships between component carriers in carrier aggregation and inferring CSI information for component carriers that are sufficiently related.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol (e.g., 5G-advanced networks, 6G networks, etc.), or any other type of network.

The example embodiments are described with reference to carrier aggregation (CA). In CA, a UE may communicate in the downlink (DL) or uplink (UL) with multiple cells of a network to increase throughput. CA includes the UE associating with a Primary Cell (PCell) and one or more Secondary Cells (SCells). Different band combinations of CA may be served by the PCell and SCell, e.g., the PCell may serve a first component carrier (CC) of a CA band combination (e.g., CC1 or primary component carrier (PCC)) to the UE and the SCell may serve a second CC of the CA band combination (e.g., CC2 or secondary component carrier (SCC)) to the UE. Thus, in CA, both the PCell and the SCell are considered to be serving cells.

The example embodiments are also described with reference to downlink reference signals that are transmitted by a cell (e.g., gNB) of a network. The downlink reference signals are predefined signals occupying specific resource elements (REs) within the downlink time-frequency grid. There may be several types of downlink reference signals that are transmitted in different manners and used for different purposes by a UE. In a first example, CSI reference signals (CSI-RS) may be specifically intended to be used by UEs to acquire channel-state information (CSI) and beam specific information (e.g., beam Reference Signal Received Power (RSRP)). In 5G networks, CSI-RS may be UE specific meaning that CSI-RS may have a lower time/frequency density. In a second example, demodulation reference signals (DM-RS) sometimes referred to as UE-specific reference signals may be intended to be used by UEs for channel estimation. The label “UE-specific” relates to the fact that each demodulation reference signal is intended for channel estimation by a single UE. That specific reference signal is then only transmitted within the resource blocks assigned for data traffic channel transmissions to that UE. The description of these reference signals are only examples and the example embodiments are not limited to these types of reference signals.

The example embodiments are also described with reference to quasi collocated (QCL) antenna ports. Generally, when there are multiple antennas at the transmitter, the channel characteristics such as delay spread, multipath profile, etc. may vary between the antenna ports. However, some antenna ports may have the same profile. These antenna ports having the same profile may be referred to as being QCL. Again, while the example embodiments are described with reference to QCL antenna ports, it is not a requirement of the example embodiments.

The example embodiments are also described with reference to CSI reporting. The CSI reports for a component carrier may include, for example, a CSI-RS Resource Indicator (CRI), a Rank Indicator (RI), a Layer Indicator, a Precoding Matrix Indicator (PMI) for wideband (X1 and X2) and a Wideband Channel Quality Indicator (CQI). These parameters may be reported in a CSI Report that comprises a CSI Part I and a CSI Part II. Again, the CSI report and the parameters for the SCI report are only examples and the example embodiments may be applied to different types of reports and/or different types of parameters, including partial information for the above mentioned parameters.

Some example embodiments provide operations for a base station to determine that a PCC correlates to an SCC such that CSI information for the PCC may be used for the SCC. Use of the CSI information of the PCC to infer the CSI information for the SCC may allow the base station to schedule the SCC even when the baser station has not received CSI information for the SCC and may also allow the base station to transmit reference signals on the SCC based on a larger periodicity than the periodicity of reference signals being transmitted on the PCC. Other example embodiments are related to operations for a UE to determine that a PCC correlates to an SCC such that CSI information for the PCC may be used for the SCC UE. Use of the CSI information of the PCC to infer the CSI information for the SCC may allow the UE to skip certain reference signal measurements on the SCC. Each of these example embodiments will be described in greater detail below.

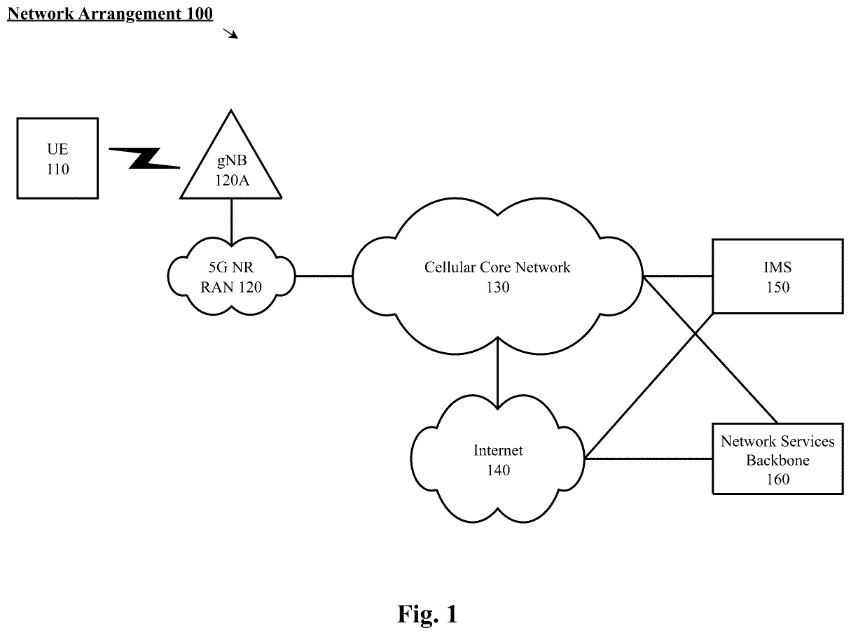

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. The UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A and the gNB 120B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A). In the example of FIG. 1, the gNB 120A may represent any of a PCell, an activated SCell, an SCell to be activated or a deactivated SCell as will be described in greater detail below.

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

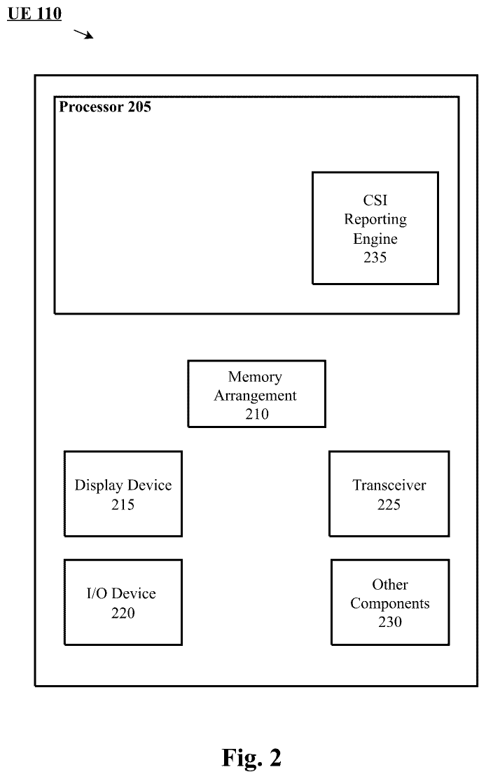

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a CSI reporting engine 235 for performing operations related to reporting CSI for a PCC and one or more SCCS. The operations include, but are not limited to, determining an SCC correlates to a PCC, determine CSI information for the SCC based on the CSI information for the PCC without measuring CSI-RS on the SCC and report the CSI information for the PCC and SCC to the network. Each of these example operations will be described in more detail below.

The above referenced engine being an application (e.g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

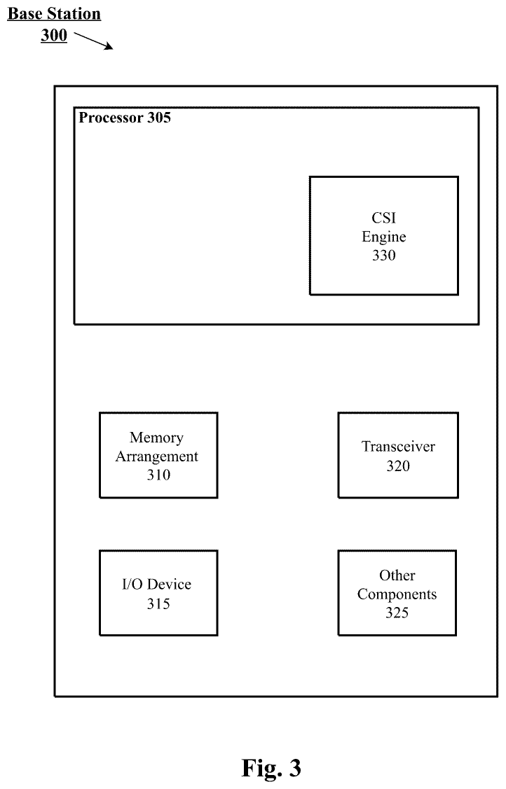

FIG. 3 shows an example base station 300 according to various example embodiments. The base station 300 may represent the gNB 120A, the gNB 120B or any other access node through which the UE 110 may establish a connection and manage network operations. As described above, the base station 300 may represent any of a PCell, an activated SCell, an SCell to be activated or a deactivated SCell, e.g., the base station 300 may perform any of the operations described for these different cells throughout this description.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a CSI engine 330 for performing operations related to configuring CSI reporting for a UE and using CSI information for scheduling the UE. The operations include, but are not limited to, sending a CSI configuration to the UE comprising a PCC configuration and an SCC configuration, receiving CSI information for the PCC from the UE, determining CSI information for the SCC based on the CSI information for the PCC and scheduling the UE on the SCC without receiving CSI information for the SCC from the UE. Each of these example operations will be described in more detail below.

The memory arrangement 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

As described above, when a UE is configured with multiple component carriers, the UE may report the feedback for each component carrier on the uplink carrier. This causes a substantial overhead on the uplink channel. To provide a specific example, in an urban environment, a network operator may deploy mid-band frequencies with multiple component carriers to provide high capacity and maintain good coverage. For example, a three (3) component carrier deployment may be configured as follows: a PCell on band n78 (3.3-3.8 GHz) with a bandwidth of 100 MHz may be used as the anchor band because of its balance between coverage and capacity; an SCell on band n77 (3.3-4.2 GHz) with a bandwidth of 100 MHz may be aggregated with the primary carrier to enhance the overall data throughput because this band overlaps with n78, providing additional spectrum and improving capacity; and an SCell on band n41 (2.5-2.7 GHz) with a bandwidth of 60 MHz may be aggregated to further boost the available bandwidth because this band, while slightly lower in frequency, complements the primary and first secondary carriers by providing additional capacity. However, reporting the CSI-RS information for each of the component carriers may be a burden on the uplink control channel.

The example embodiments may reduce the amount of CSI reporting in the carrier aggregation scenario based on the observation that when a base station (e.g., gNB) deploys multiple component carriers, the carriers belonging to a specific frequency band typically share the same antenna configuration. For example, all component carriers in the mid-band may use 32 transmit (Tx) antennas, while carriers in the low band may use only 4 Tx antennas. As a result, the CSI reported by UEs for one component carrier in a band may have some correlation with the CSI for other component carriers in the same band. This correlation may be used by the base station to make informed scheduling decisions for SCCs, even if it has not received specific CSI for those secondary carriers from the UE. By leveraging the known correlation between component carriers within the same band, the base station may infer the necessary CSI for the SCCs, thereby optimizing resource allocation and improving overall network performance.

For example, the rank information and some other parameters related to CSI reporting such as wideband precoding (X1) may not differ significantly when two component carriers are adjacent or in the same band and QCL. This relationship may be determined based on measured parameters and/or simulations. The following provides an example of a simulation that may be performed to determine correlations or relationships between component carriers. This simulation was performed based on the above example deployment scenario, e.g., n78, n77 and n41. However, this is only an example that is used to demonstrate how relationships may be determined to implement the example embodiments. Specific simulations and/or measurements may result in different correlations based on different factors such as component carrier frequency, number of Tx antennas, transmit power, pathloss model, subcarrier spacing (SCS), location of Tx antennas, etc.

In one example, a link simulator was performed with different carrier frequencies. The signal to interference noise ratio (SINR) may be adjusted to account for the additional path loss (as a function of frequency). For example, if the UE has an SINR of 23.9 dB at a carrier frequency of 3.3 GHz, then the SINR may be adjusted to 23.6 dB when the carrier frequency is changed to 3.6 GHz and may be adjusted to 25.2 dB when the carrier frequency is changed to 3 GHz, etc. Once SINR is determined, a link simulation with the corresponding SINR may be performed at 3 different signal to noise ratios (SNRs) (e.g., high, medium and low). The link simulation assumptions may include carrier frequency, duplexing type (e.g., frequency division duplexing (FDD), time division duplexing (TDD)), system bandwidth, slot length, SCS, Fast Fourier Transform (FFT) size, data transmission bandwidth, antenna configuration, number of codewords, channel encoder, Modulation and Control Scheme (MCS), control overhead, channel estimation, UE speed, channel model, number of CSI-RS ports, etc.

In the example simulation, the PCC of the UE may be a reference carrier. The PCC may be at 3.5 GHz and have an SINR of 23.859 dB. The UE may report a RI of 3 in the CSI report for the PCC based on these parameters. The simulation may show that when the UE uses a SCC at 3.6 GHz with the SINR adjusted to 23.6143 dB to account for the additional path loss due to the carrier frequency, the RI (e.g., value of 3) may be exactly same for both the carriers. As will be described in greater detail below, the network may leverage this knowledge that CSI report parameters are similar for different component carriers to activate a SCC without receiving a CSI report for the component carrier.

Similarly, if the UE reports a PMI index (i11) that indicates the azimuth beam index out of (N1*O1=32) beams for the PCC (e.g., 3.5 GHz with an SINR of 23.859 dB), the simulation may show that the PMI index (i11) for the SCC at the frequency of 3.6 GHz may be exactly the same as that of the reference carrier (e.g., the PCC). This may be expected as the UE may be stationary and the azimuth beam index does not change.

In a further example, the CQI reported by the UE for the reference component carrier (e.g., the PCC at 3.5 GHz with an SINR of 23.859 dB) and the SCC (e.g., 3.6 GHz with the SINR adjusted to 23.6143 dB) may also be similar. This is expected because the RI is same and the SINR is almost equal. In general, there should be almost no difference in the CQI when the SINR is within 2 dB because the CQI table is designed such that the entries have approximately a 2 dB SINR difference.

Thus, the simulation shows that repeating this at different SNRs, the RI and PMI is exactly same and the CQI differed by +1 or −1 when the relative difference between the component carriers changes from 3.5 GHz to 3 GHz or 4 GHz. This is expected as the change in frequency of the component carrier results in a change in SINR as described above.

Thus, based on these observed relationships or correlations between the PCC and one or more SCCs, the network may use the reported CSI information for the PCC to schedule a SCC even if the UE has not reported CSI information for the SCC.

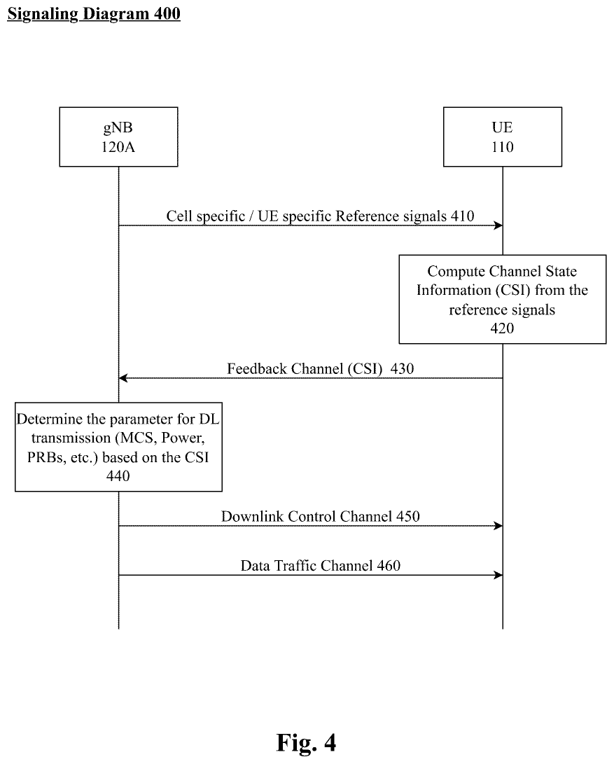

FIG. 4 shows a signaling diagram 400 illustrating a call flow for CSI reporting between a base station and a UE according to the various example embodiments. The base station may be, for example, the gNB 120A described above and the UE may be, for example, the UE 110 also described above. Prior to the start of the call flow of the signaling diagram 400, the UE 110 may have received a CSI configuration from the gNB 120A allowing the UE 110 to understand the time/frequency resources that will be used by the gNB 120A to transmit the reference signals, the type of CSI reporting (e.g., when the UE 110 should perform the CSI reporting (e.g., periodic, aperiodic, semi-persistent) and the information expected in the CSI report (e.g., CRI, RI, layer indicator, PMI, CQI, etc.). This CSI configuration may be for the PCC and one or more SCCs that are configured for the UE 110. In the example of FIG. 4, the SCCs that are described may be activated SCCs. In addition, the UE 110 may be in a radio resource control (RRC) Connected state when performing the call flow of the signaling diagram 400.

In 410, the gNB 120A may transmit the cell specific or UE specific reference signals (e.g., CSI-RS, DM-RS, etc.) according to the CSI configuration provided to the UE 110. In 420, the UE 110 may perform measurements on the reference signals and compute the CSI based on the measurements. In some example embodiments, the UE 110 may perform measurements on reference signals in the PCC and one or more SCCs. In other example embodiments, as will be described in greater detail below, the UE 110 may skip performing measurements on some or all of the SCCs.

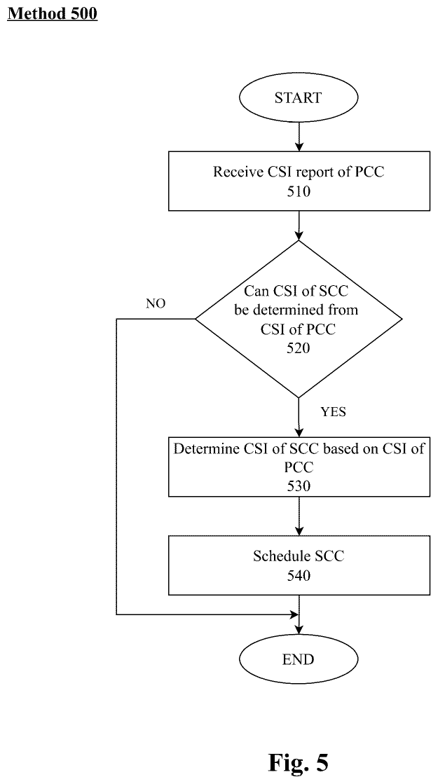

In 430, the UE 110 will provide the CSI reporting to the gNB 120A according to the CSI configuration. In this example, the CSI reporting may only include the CSI for the PCC. As will be described in greater detail below with reference to FIG. 5, the gNB 120A may determine CSI for one or more SCCs based on the CSI for the PCC.

FIG. 5 shows an example method 500 for a base station to determine CSI for a secondary component carrier (SCC) based on CSI reported for a primary component carrier (PCC) according to various example embodiments. The base station may be, for example, the gNB 120A described above. In this example, the PCC is the reference CC and the CSI for one or more SCCs may be determined from the CSI of the PCC. However, the example embodiments are not limited to the PCC being the reference CC. For example, in some example embodiments, one of the SCCs may be the reference CC and the CSI for one or more of the remaining SCCs may be determined based on the CSI of the reference SCC.

In 510, the gNB 120A may receive the CSI report for the PCC from the UE 110, e.g., the operation 430 of the call flow of the signaling diagram 400. In 520, the gNB 120A may determine whether the CSI of an SCC may be determined from the CSI of the PCC.

For example, in some example embodiments, the gNB 120A may determine if a difference between the reference component carrier frequency (f_{ref}) where the CSI is obtained from the UE 110 (e.g., the PCC) and a second component carrier frequency (f_{sec}) for which no CSI is received (e.g., one of the SCCs) is less than a predetermined threshold. The predetermined threshold in frequency may be set to any value. In one example, the predetermined threshold may be several MHz. The predetermined threshold may be set, for example, based on the simulation that indicates which frequency bands have relationships that result in similar CSI parameters.

If the difference between f_{ref} and f_{sec} is greater than the predetermined threshold, then the method 500 may be completed because the gNB 120A may determine that the CSI for the SCC cannot be determined from the CSI of the PCC because the two carriers are not close enough in frequency to be confident that the CSI for the two component carriers will be similar.

However, if the difference between f_{ref} and f_{sec} is less than the predetermined threshold, the gNB 120A may determine that the CSI for the SCC may be determined from the CSI of the PCC because the two carriers are close enough in frequency to be confident that the CSI for the two component carriers will be similar.

If this is the case, in 530, the gNB 120A may determine the CSI of the SCC based on the CSI of the PCC. For example, the gNB 120A may determine the CSI for the SCC to be RI_{sec}=RI_{ref}, PMI_{sec}=PMI_{ref} and CQI_{sec}=CQI_{ref}. Thus, in this example, the CSI for the SCC is identical to the CSI for the PCC for the described parameters.

In other example embodiments, there may be two predetermined thresholds (T₁ and T₂), where T₁ is less than T₂. The values of T₁ and T₂ may be determined in the same manner or in a different manner as the predetermined threshold described above. If the gNB 120A determines the difference between f_{ref} and f_{sec} is less than T₁, the gNB 120A may determine the CSI for the SCC in the same manner as described above when the difference between f_{ref} and f_{sec} is less than the predetermined threshold, e.g., RI_{sec}=RI_{ref}, PMI_{sec}=PMI_{ref} and CQI_{sec}=CQI_{ref}. If the gNB 120A determines the difference between f_{ref} and f_{sec} is greater than T₂, the gNB 120A may determine that the CSI for the SCC cannot be determined from the CSI of the PCC.

If the gNB 120A determines the difference between f_{ref} and f_{sec} is between T₁ and T₂, the gNB 120A may determine the CSI for the SCC to be RI_{sec}=RI_{ref}, PMI_{sec}=PMI_{ref} and CQI_{sec}=CQI_{ref} +/−1 or +/−2. This is because, in general, only the CQI changes as the SCC moves away from the reference component carrier frequency and this change in CQI may be either +1 or −1 from the reference component carrier. For example, when the SCC frequency is less than the reference component carrier frequency, the CQI_{sec}=CQI_{ref}+1 or CQI_{ref}+2. When the SCC frequency is greater than the reference component carrier frequency, the CQI_{sec}=CQI_{ref}−1 or CQI_{ref}−2.

The gNB 120A may then use the determined CSI for the SCC to schedule the SCC in 540, e.g., the gNB 120A may schedule the SCC without receiving a CSI report for the SCC from the UE 110. This scheduling is described in greater detail with reference to the description of FIG. 4 continued below.

Returning to FIG. 4, in 440, the gNB 120A determines the parameters for downlink (DL) transmission based on the CSI. These parameters may include, for example, MCS, transmit power, Physical Resource Blocks (PRBs), etc. As described above, in this example, the gNB 120 has received the CSI report for the PCC and may determine these parameters for the PCC. However, as also described above, the gNB 120A may have determined the CSI for one or more SCC based on the CSI of the PCC, e.g., as described above with reference to FIG. 5. Thus, the gNB 120A may also determine the parameters for DL transmission for the one or more SCCs for which CSI was derived from the PCC CSI.

In 450, the gNB 120A may transmit information about scheduling grants to the UE 110 via the Physical Downlink Control Channel (PDCCH). This scheduling grant information may include, for example, number of MIMO layers scheduled, transport block sizes, modulation for each codeword, parameters related to Hybrid Automatic Repeat Request (HARQ), sub-band locations, PMI corresponding to the sub-bands, etc. This scheduling grant information may be transmitted using Downlink Control Information (DCI). The contents of the PDCCH may depend on a transmission mode and the DCI format used.

In any case, because the gNB 120A determined the CSI for one or more SCCs based on the CSI of the PCC, the scheduling grant information in 450 may include scheduling grant information for these one or more SCCs even though the UE 110 did not report the CSI for these one or more SCCs.

In 460, based on the scheduling grant information transmitted in 450, the gNB 120A may transmit DL data traffic to the UE 110, e.g., via the Physical Downlink Shared Channel (PDSCH). Since the UE 110 received the scheduling grant information in 450, the UE 110 may understand that DL data traffic may be received on SCCs for which the UE 110 did not report CSI.

In addition to the faster scheduling of the SCCs, the relationships between the component carriers may also be used for resource allocation for downlink data transmissions on SCCs. Generally, the base station configures the CSI-RS parameters for each component carrier. If a periodic CSI-RS is configured on the PCC with a certain periodicity (e.g., 40 slots), then the periodicity of the CSI-RS for the SCC is also set to 40 slots. This configuration may occupy 4 symbols in a slot for 32 port CSI-RS during each CSI-RS transmission. However, using the example embodiments, signaling overhead may be reduced because the base station may not have to transmit the CSI-RS on the SCCs where the CSI can be derived from the PCC CSI at the same periodicity as the PCC. For example, the base station may use a different CSI-RS periodicity for the SCC that is greater than the periodicity of the PCC. During data transmission, the base station may use a combination of CSI received from both the SCCs and the PCCS. This approach may increase the data throughput for the SCC, as the base station may avoid wasting resources on frequent CSI-RS transmissions for the SCC.

The above examples provided operations that were performed on the network side. The same principle of correlations between component carriers may also be applied at the UE side while computing and reporting the CSI for the secondary carrier. For example, if the base station configures the UE to report CSI on two adjacent component carriers, the UE may simplify the process according to the example embodiments.

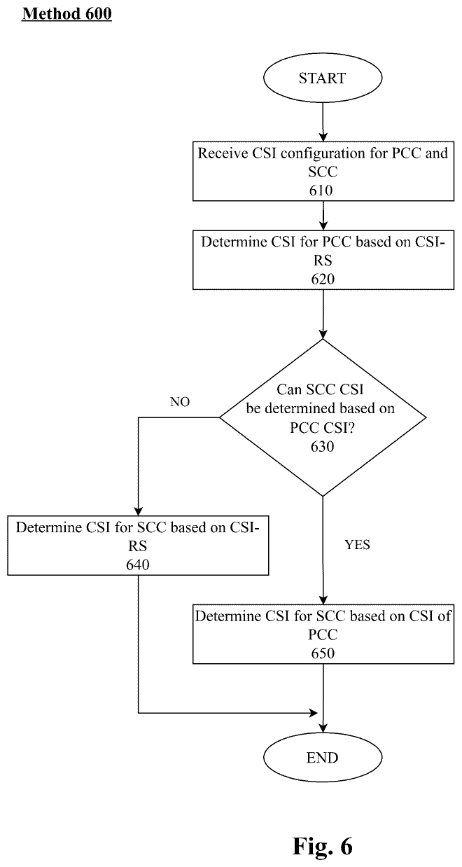

FIG. 6 shows an example method 600 for a UE to simplify CSI reporting according to various example embodiments. The method 600 may be performed by the UE 110 described above. Similar to the example described above with reference to FIG. 5, the example of FIG. 6 is described from the standpoint of the UE 110 using the PCC as the reference component carrier. However, as described above, an SCC may also be used as a reference component carrier in the method 600.

In 610, the UE may receive a CSI configuration from the network, e.g., gNB 120A. An example of information that may be included in a CSI configuration was described above. The CSI configuration may include parameters for both the PCC and one or more SCCs.

In 620, the UE 110 may perform measurements on the CSI-RS transmitted by the base station on the PCC (e.g., reference component carrier). Based on the measurements, the UE 110 may determine the CSI for the PCC.

In 630, the UE 110 may determine whether the CSI of an SCC may be determined from the CSI of the PCC. This operation is similar to the operation performed by the gNB 120A in 520 of method 500. That is, the UE 110 determines if there is a correlation between the PCC and one or more SCCs based on, for example, the frequency of the PCC and the frequency of the SCC as described above, e.g., using the predetermined threshold, or the two thresholds T₁ and T₂. The thresholds may be the same as the thresholds used by the gNB or may be set at different values.

If the UE 110 determines that the relationship between the PCC and the SCC is not sufficiently close for the CSI of the PCC to be used to determine the CSI of the SCC, in 640, the UE 110 may determine the CSI of the SCC in the standard manner, e.g., by measuring the CSI-RS transmitted by the base station.

On the other hand, if the UE 110 determines that the relationship between the PCC and the SCC is sufficiently close for the CSI of the PCC to be used to determine the CSI of the SCC, in 650, the UE 110 may determine the CSI for the SCC without performing the CSI-RS measurements for the SCC. For example, the UE 110 may determine the CSI parameters for the SCC using the CSI of the PCC in the same manner as described above for the gNB 120A. The UE 110 may then report the CSI for the PCC and the SCC to the network.

In some example embodiments, the UE may also use the operations of the method 600 to determine power consumption gains. For example, if the UE is configured with CA with multiple CCs active, the UE may cycle through the set of CCs (within the same band/adjacent bands that have the same antenna configuration) where CSI measurements are performed. This may reduce the frequency of actual CSI measurements.

Thus, the example embodiments may be used to reduce latency based on the ability to determine CSI parameters for SCCs without requiring direct CSI reports to enable faster and more flexible scheduling decisions. This may result in more timely and efficient utilization of secondary carriers, reducing delays and enhancing the responsiveness of the network to dynamic traffic conditions. This may also reduce latency in data transmissions, which may be crucial for applications requiring real-time responsiveness, such as augmented reality (AR), virtual reality (VR), and ultra-reliable low-latency communications (URLLC).

The example embodiments may also be used to reduce overhead. By deriving CSI parameters for SCCs from the PCC, the example embodiments minimize the need for frequent CSI-RS transmissions. This reduction in overhead frees up valuable time-frequency resources, allowing for more efficient data transmission and improving overall network performance.

The example embodiments may also simplify UE processing because computing CSI for the primary carrier and deriving CSI for adjacent carriers reduces computational complexity. This simplification allows the UE to conserve processing power and resources, which can be redirected towards other critical functions, thereby enhancing the overall efficiency of the UE.

### Examples

In a first example, a method, comprising generating, for transmission to a user equipment (UE), a Channel State Information (CSI) configuration for a first component carrier (CC) and a second CC of a carrier aggregation (CA) scheme, processing, based on signaling received from the UE, CSI information for the first CC, determining CSI information for the second CC based on the CSI information for the first CC and generating, for transmission to the UE, scheduling information for the second CC based on the CSI information for the second CC.

In a second example, the method of the first example, wherein the CSI information for the second CC is determined based on determining a difference between a frequency of the first CC and a frequency of the second CC is less than a predetermined threshold.

In a third example, the method of the second example, wherein the CSI information for the second CC comprises a Rank Indicator (RI), a Precoding Matrix Indicator (PMI) or a Channel Quality Indicator (CQI).

In a fourth example, the method of the third example, wherein a value of the RI of the second CC comprises a same value as an RI of the first CC, a value of the PMI of the second CC comprises a same value as a PMI of the first CC or a value of the CQI of the second CC comprises a same value as a CQI of the first CC.

In a fifth example, the method of the first example, wherein the CSI information for the second CC is determined based on determining a difference between a frequency of the first CC and a frequency of the second CC is less than a first predetermined threshold or less than a second predetermined threshold, wherein the second predetermined threshold has a value greater than the first predetermined threshold.

In a sixth example, the method of the fifth example, wherein the CSI information for the second CC comprises a Rank Indicator (RI), a Precoding Matrix Indicator (PMI) or a Channel Quality Indicator (CQI).

In a seventh example, the method of the sixth example, wherein, when the frequency of the first CC and the frequency of the second CC is less than the first predetermined threshold, a value of the RI of the second CC comprises a same value as an RI of the first CC, a value of the PMI of the second CC comprises a same value as a PMI of the first CC or a value of the CQI of the second CC comprises a same value as a CQI of the first CC.

In an eighth example, the method of the sixth example, wherein, when the frequency of the first CC and the frequency of the second CC is greater than the first predetermined threshold and less than the second predetermined threshold, a value of the RI of the second CC comprises a same value as an RI of the first CC, a value of the PMI of the second CC comprises a same value as a PMI of the first CC or a value of the CQI of the second CC comprises a value of a CQI of the first CC+1 or a value of a CQI of the first CC+2 when the frequency of the first CC is greater than the frequency of the second CC or the value of the CQI of the first CC−1 or a value of a CQI of the first CC−2 when the frequency of the first CC is less than the frequency of the second CC.

In a ninth example, the method of the first example, wherein the CSI configuration for the first CC comprises a first periodicity for transmission of CSI-reference signals (CSI-RS) on the first CC and the CSI configuration for the second CC comprises a second periodicity for transmission of CSI-RS on the second CC, wherein the second periodicity is longer than the first periodicity.

In a tenth example, the method of the ninth example, further comprising processing, based on signaling received from the UE, second CSI information for the second CC based on measurements of the CSI-RS transmitted on the second CC and generating, for transmission to the UE, second scheduling information for the second CC based on the second CSI information for the second CC.

In an eleventh example, the method of the first example, wherein the scheduling information for the second CC comprises a downlink (DL) grant indicating time and frequency resources on which the UE is to receive data.

In a twelfth example, the method of the first example, wherein the first CC and the second CC are within a same frequency band.

In a thirteenth example, the method of the first example, wherein the first CC comprises a primary component carrier (PCC) or a first secondary component carrier (SCC) and the second CC comprises the PCC, the first SCC or a second SCC.

In a fourteenth example, a processor configured to perform any of the first through thirteenth examples.

In a fifteenth example, a base station configured to perform any of the first through thirteenth examples.

In a sixteenth example, a method, comprising processing, based on signaling received from a base station, a Channel State Information (CSI) configuration for a first component carrier (CC) and a second CC of a carrier aggregation (CA) scheme, determining, based on measurements of CSI reference signals (CSI-RS), CSI information for the first CC, determining CSI information for the second CC based on the CSI information for the first CC and generating, for transmission to the base station, one or more messages comprising the CSI information for the first CC and the CSI information for the second CC.

In a seventeenth example, the method of the sixteenth example, wherein the CSI information for the second CC is determined based on determining a difference between a frequency of the first CC and a frequency of the second CC is less than a predetermined threshold.

In an eighteenth example, the method of the seventeenth example, wherein the CSI information for the second CC comprises a Rank Indicator (RI), a Precoding Matrix Indicator (PMI) or a Channel Quality Indicator (CQI).

In a nineteenth example, the method of the eighteenth example, wherein a value of the RI of the second CC comprises a same value as an RI of the first CC, a value of the PMI of the second CC comprises a same value as a PMI of the first CC or a value of the CQI of the second CC comprises a same value as a CQI of the first CC.

In a twentieth example, the method of the sixteenth example, wherein the CSI information for the second CC is determined based on determining a difference between a frequency of the first CC and a frequency of the second CC is less than a first predetermined threshold or less than a second predetermined threshold, wherein the second predetermined threshold has a value greater than the first predetermined threshold.

In a twenty first example, the method of the twentieth example, wherein the CSI information for the second CC comprises a Rank Indicator (RI), a Precoding Matrix Indicator (PMI) or a Channel Quality Indicator (CQI).

In a twenty second example, the method of the twenty first example, wherein, when the frequency of the first CC and the frequency of the second CC is less than the first predetermined threshold, a value of the RI of the second CC comprises a same value as an RI of the first CC, a value of the PMI of the second CC comprises a same value as a PMI of the first CC or a value of the CQI of the second CC comprises a same value as a CQI of the first CC.

In a twenty third example, the method of the twenty first example, wherein, when the frequency of the first CC and the frequency of the second CC is greater than the first predetermined threshold and less than the second predetermined threshold, a value of the RI of the second CC comprises a same value as an RI of the first CC, a value of the PMI of the second CC comprises a same value as a PMI of the first CC or a value of the CQI of the second CC comprises a value of a CQI of the first CC+1 or a value of a CQI of the first CC+2 when the frequency of the first CC is greater than the frequency of the second CC or the value of the CQI of the first CC−1 or a value of a CQI of the first CC−2 when the frequency of the first CC is less than the frequency of the second CC.

In a twenty fourth example, the method of the sixteenth example, wherein the first CC comprises a primary component carrier (PCC) or a first secondary component carrier (SCC) and the second CC comprises the PCC, the first SCC or a second SCC.

In a twenty fifth example, a processor configured to perform any of the fourteenth through twenty fourth examples.

In a twenty sixth example, a user equipment (UE) configured to perform any of the fourteenth through twenty fourth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
generate, for transmission to a user equipment (UE), a Channel State Information (CSI) configuration for a first component carrier (CC) and a second CC of a carrier aggregation (CA) scheme;
process, based on signaling received from the UE, CSI information for the first CC;
determine CSI information for the second CC based on the CSI information for the first CC; and
generate, for transmission to the UE, scheduling information for the second CC based on the CSI information for the second CC.

2. The apparatus of claim 1, wherein the CSI information for the second CC is determined based on the processing circuitry being configured to:
determine a difference between a frequency of the first CC and a frequency of the second CC is less than a predetermined threshold.

3. The apparatus of claim 2, wherein the CSI information for the second CC comprises a Rank Indicator (RI), a Precoding Matrix Indicator (PMI) or a Channel Quality Indicator (CQI).

4. The apparatus of claim 3, wherein a value of the RI of the second CC comprises a same value as an RI of the first CC, a value of the PMI of the second CC comprises a same value as a PMI of the first CC or a value of the CQI of the second CC comprises a same value as a CQI of the first CC.

5. The apparatus of claim 1, wherein the CSI information for the second CC is determined based on the processing circuitry being configured to:
determine a difference between a frequency of the first CC and a frequency of the second CC is less than a first predetermined threshold or less than a second predetermined threshold, wherein the second predetermined threshold has a value greater than the first predetermined threshold.

6. The apparatus of claim 5, wherein the CSI information for the second CC comprises a Rank Indicator (RI), a Precoding Matrix Indicator (PMI) or a Channel Quality Indicator (CQI).

7. The apparatus of claim 6, wherein, when the frequency of the first CC and the frequency of the second CC is less than the first predetermined threshold, a value of the RI of the second CC comprises a same value as an RI of the first CC, a value of the PMI of the second CC comprises a same value as a PMI of the first CC or a value of the CQI of the second CC comprises a same value as a CQI of the first CC.

8. The apparatus of claim 6, wherein, when the frequency of the first CC and the frequency of the second CC is greater than the first predetermined threshold and less than the second predetermined threshold, a value of the RI of the second CC comprises a same value as an RI of the first CC, a value of the PMI of the second CC comprises a same value as a PMI of the first CC or a value of the CQI of the second CC comprises a value of a CQI of the first CC+1 or a value of a CQI of the first CC+2 when the frequency of the first CC is greater than the frequency of the second CC or the value of the CQI of the first CC−1 or a value of a CQI of the first CC−2 when the frequency of the first CC is less than the frequency of the second CC.

9. The apparatus of claim 1, wherein the CSI configuration for the first CC comprises a first periodicity for transmission of CSI-reference signals (CSI-RS) on the first CC and the CSI configuration for the second CC comprises a second periodicity for transmission of CSI-RS on the second CC, wherein the second periodicity is longer than the first periodicity.

10. The apparatus of claim 9, wherein the processing circuitry is further configured to:
process, based on signaling received from the UE, second CSI information for the second CC based on measurements of the CSI-RS transmitted on the second CC; and
generate, for transmission to the UE, second scheduling information for the second CC based on the second CSI information for the second CC.

11. The apparatus of claim 1, wherein the scheduling information for the second CC comprises a downlink (DL) grant indicating time and frequency resources on which the UE is to receive data.

12. The apparatus of claim 1, wherein the first CC and the second CC are within a same frequency band.

13. The apparatus of claim 1, wherein the first CC comprises a primary component carrier (PCC) or a first secondary component carrier (SCC) and the second CC comprises the PCC, the first SCC or a second SCC.

14. An apparatus comprising processing circuitry configured to:
process, based on signaling received from a base station, a Channel State Information (CSI) configuration for a first component carrier (CC) and a second CC of a carrier aggregation (CA) scheme;
determine, based on measurements of CSI reference signals (CSI-RS), CSI information for the first CC;
determine CSI information for the second CC based on the CSI information for the first CC; and
generate, for transmission to the base station, one or more messages comprising the CSI information for the first CC and the CSI information for the second CC.

15. The apparatus of claim 14, wherein the CSI information for the second CC is determined based on the processing circuitry being configured to:
determine a difference between a frequency of the first CC and a frequency of the second CC is less than a predetermined threshold.

16. The apparatus of claim 16, wherein the CSI information for the second CC comprises a Rank Indicator (RI), a Precoding Matrix Indicator (PMI) or a Channel Quality Indicator (CQI), and
wherein a value of the RI of the second CC comprises a same value as an RI of the first CC, a value of the PMI of the second CC comprises a same value as a PMI of the first CC or a value of the CQI of the second CC comprises a same value as a CQI of the first CC.

17. The apparatus of claim 14, wherein the CSI information for the second CC is determined based on the processing circuitry being configured to:
determine a difference between a frequency of the first CC and a frequency of the second CC is less than a first predetermined threshold or less than a second predetermined threshold, wherein the second predetermined threshold has a value greater than the first predetermined threshold.

18. The apparatus of claim 17, wherein the CSI information for the second CC comprises a Rank Indicator (RI), a Precoding Matrix Indicator (PMI) or a Channel Quality Indicator (CQI), and,
when the frequency of the first CC and the frequency of the second CC is less than the first predetermined threshold, a value of the RI of the second CC comprises a same value as an RI of the first CC, a value of the PMI of the second CC comprises a same value as a PMI of the first CC or a value of the CQI of the second CC comprises a same value as a CQI of the first CC.

19. The apparatus of claim 17, wherein the CSI information for the second CC comprises a Rank Indicator (RI), a Precoding Matrix Indicator (PMI) or a Channel Quality Indicator (CQI), and,
when the frequency of the first CC and the frequency of the second CC is greater than the first predetermined threshold and less than the second predetermined threshold, a value of the RI of the second CC comprises a same value as an RI of the first CC, a value of the PMI of the second CC comprises a same value as a PMI of the first CC or a value of the CQI of the second CC comprises a value of a CQI of the first CC+1 or a value of a CQI of the first CC+2 when the frequency of the first CC is greater than the frequency of the second CC or the value of the CQI of the first CC−1 or a value of a CQI of the first CC−2 when the frequency of the first CC is less than the frequency of the second CC.

20. The apparatus of claim 14, wherein the first CC comprises a primary component carrier (PCC) or a first secondary component carrier (SCC) and the second CC comprises the PCC, the first SCC or a second SCC.
